(19) United States
(12) Patent Application Publication
(10) Pub. No.: US 2006/0190594 A1
(43) Pub. Date: Aug. 24, 2006

(54) Method and apparatus for evaluation of service quality of a real time application operating over a packet-based network

(75) Inventors: Loki Michael Jorgenson, Vancouver (CA); Robert Christopher Norris, Vancouver (CA)

Correspondence Address: DLA PIPER RUDNICK GRAY CARY US, LLP, 4365 EXECUTIVE DRIVE, SUITE 1100, SAN DIEGO, CA, 92121-2133, US

(73) Assignee: APPARENT NETWORKS, INC., Vancouver (CA)

(21) Appl. No.: 11/349,379

(22) Filed: Feb. 6, 2006

Related U.S. Application Data
(60) Provisional application No. 60/650,059, filed on Feb. 4, 2005.

(51) Int. Cl. G06F 15/173

(52) U.S. Cl. 709/224

(57) ABSTRACT

The present invention provides a method and apparatus for determining the service quality performance of a real-time application, for example VoIP, video over IP or IPTV, operating over a path defined in a packet-based network. The present invention performs active probing of a path of the packet-based network by transmitting one or more sequences of packets along the path.

### RELATED APPLICATION DATA

This application claims priority under 35 U.S.C. §119 (e) to U.S. Patent Application Ser. No. 60/650,059 filed on Feb. 4, 2005 which is herein incorporated by reference in its entirety.

### FIELD OF THE INVENTION

The present invention pertains to the field of packet-based network evaluation and in particular to a method and apparatus for the evaluation of service quality of a real-time application operating over a packet-based network.

### BACKGROUND

A typical data communication network comprises a number of packet handling devices interconnected by data links, a collection of which form a path. The packet handling devices may comprise, for example, routers, switches, bridges, firewalls, gateways, hubs or similar devices. The data links may comprise physical media segments such as electrical cables of various types, fibre optic cables, and the like or transmission type media such as radio links, laser links, ultrasonic links, or similar links. Various communication protocols may be used to carry data across the data links, wherein data can be carried between two points in such a network by traversing a path, which includes one or more data links connecting the two points.

A large network can be very complicated. The correct functioning of such a network requires the proper functioning and cooperation of a large number of different systems, and these systems may not be under common control. A network may provide less than optimal performance in delivering data packets between two points for any of a wide variety of reasons including complete or partial failure of a packet handling device, mis-configuration of hardware components or mis-configuration of software, for example. These factors can interact with one another in subtle ways and defects or mis-configurations of individual network components can have severe effects on the performance of the network.

For a multimedia communications system in which audio, voice or video is digitized, compressed, formed into packets, transmitted over a packet network and then re-assembled and decoded by a receiving system, there are several circumstances wherein the quality of this transmission may be diminished. Typical packet networks cause some packets to be lost or delayed which results in the quality of a decoded audio, voice or video being degraded, impacting the quality as perceived by the end user. It is accordingly desirable to have some means of measuring or estimating the subjective or perceptual quality of the decoded audio, voice or video that is specific to the effect of packet networks.

Emerging packet-based voice transmission networks using technology such as Voice over Internet Protocol, (VoIP), provide a more flexible and lower cost alternative to traditional telecommunication networks. In particular VoIP is a technology that allows one to make a telephone call using a packet-based network, for example a broadband Internet connection. However, technologies like VoIP for example, do introduce some problems, notably increased variation in user perceived speech quality due to network impairments.

For example, a VoIP system comprises two or more conversion points and a connecting network. A conversion point is a device that converts analog voice into packet format suitable for transmission over a network. A conversion point may be a device within a telephone switching system, a packet voice telephone, a personal computer running an application program or other types of devices, for example. At each conversion point the analog voice signal from the user's telephone is converted into a digital format, divided into short segments, compressed, placed into an IP packet and then transmitted over the connecting network to the remote conversion point. Received voice packets are uncompressed, converted back to analog form and played to the user as an audible signal.

The connecting network relays the IP packets from one conversion point to another. The network is a shared resource and can be carrying many other streams of packet data. This means that the transmission of any given packet may be subject to impairments, for example 1) Latency, in which the time for the packet to get from one conversion point to the other conversion point causes delays in the apparent response from one user to the other; 2) Packet loss, in which some of the packets are lost; 3) Jitter, in which the arrival time of the packets varies and in some cases the packets arrive so late that they are discarded; and 4) Discard, in which a packet is discarded or deleted, which can result from for example, insufficient buffer size at a handling device, a preconfigured packet handling protocol at a handling device like a firewall, jitter or other reasons as would be known to a worker skilled in the art. Each of these four factors is related to the IP network being used. In addition, other potential impairments are Distortion, which is due largely to the voice compression algorithm in use and Echo, which is due largely to the latency of the network path. These impairments collectively can cause the user perceived voice quality to vary considerably and hence VoIP service providers need a method for estimating the quality of service provided by their network, namely a Voice Quality of Service.

Prior art systems for measuring voice quality, as described by for example, U.S. Pat. Nos. 5,710,791 and 5,867,813, use centralized testing equipment which sample the voice quality from various conversion points. A loop back condition is established at a conversion point and the test equipment transmits a known signal and then compares the received or looped back signal with the original signal, thereby estimating delay, distortion and other impairments. This approach can provide an accurate measure of voice distortion but typically can only provide this measure for a sample conversion point under network conditions that existed at the time of the test.

Another approach currently used for estimating voice quality is to estimate the subjective performance of the voice connection using objectively measured parameters. Models such as the E-Model described by Johannesson in “The FTSI Computational Model”, IEEE Communications Magazine, January 1997, pages 70-79, are able to produce R ratings, which can be correlated to user perceived voice quality. This process is applied by a central management system which gathers statistics on noise and delay and then produces an estimate of voice quality. This method as described by Johannesson however, does not consider impairments typical of packet-based networks.

Specifically, the E-model describes a psycho-acoustic computational model for predictive analysis of subjective user experience. The general form of the E-model as established by the ITU G.107 standard, is as follows:
R=Rₒ−Iₛ−I_{d}−Iₑ+A (1)

where R is the transmission rating factor, Rₒ is the basic signal-to-noise ratio, Iₛ is the simultaneous impairment factor, I_{d} is the delay impairment factor, Iₑ is the equipment impairment factor and A is the expectation factor.

As the E-model was not specifically designed for packet-based networks, there are no explicit definitions for packet loss impairment. The term Iₑ refers to a range of equipment-specific effects and includes the influence of packet loss, effective loss due to jitter and other network degradations. As such most implementations of the E-model that are applied to VoIP focus on defining a loss impairment model for defining the term Iₑ. As an example, experimental studies of perceived quality relative to controlled packet loss can produce mappings on a per-codec (coder/decoder) basis between packet loss and the equipment impairment factor (Iₑ).

For example, FIG. 1 graphically represents experimental correlations between mouth-to-ear (M2E) delays and the delay impairment factor (I_{d}). Furthermore, FIG. 2 graphically represents experimental correlations between percent packet loss and the equipment impairment factor Iₑ, for a variety of codecs.

For example, U.S. Pat. No. 6,741,569 discloses a subjective quality monitoring system for packet-based multimedia signal transmission systems employing the E-model. This monitoring system provides a means of estimating subjective quality in packet multimedia communication systems. The communication system is presumed to have a low packet loss state and one or more high packet loss states and the statistical distribution of time spent in each state is determined to predict the degradation in subjective quality caused by said packet loss. This information is combined with estimated degradation in subjective quality due to other communication system impairments in order to provide an estimated subjective quality measure for the multimedia communication system. This system derives a loss impairment factor from a model based on the temporal distribution of packet losses, typically for packets associated with a VoIP connection and therefore is based upon passively monitored data. This system can provide a detailed analysis of a particular call for the period of the connection, however there are several disadvantages. For example, data used for the analysis is collected during the time of one or more actual calls and as such VoIP type calls must be taking place in order for appropriate measures to be collected. Therefore without a VoIP call a network path cannot be measured and subsequently evaluated for quality of service. Furthermore the measures collected using this technique are associated with a single point in the path and do not represent an end-to-end view of the path used during the actual call. In addition this technique does not enable the evaluation of arbitrary network paths unless call traffic is flowing along those paths.

As identified, existing systems apply methods for network assessment that have requirements that can limit their benefits. For example simulated traffic can be transmitted and the response of the network can be measured to derive an assessment. In this instance, a degraded performance may be detected. This technique however, offers limited insight into the source and the contributing factors of the transmission degradation. Furthermore, a system using this method typically requires the installation of agents at each node of interest. An alternate technique is the use of passive monitoring of VoIP transmissions, which can generate data that is analyzed on a per-call basis. This technique can provide a means for evaluating the subjective quality experienced by the end-user, however it similarly does not diagnose the source of a detected degradation. In addition this technique may not detect a source of degradation unless the source of this degradation is actually active during the time of the test, namely during the call itself.

Therefore there is a need for a new method and apparatus for the evaluation of service quality that can be provided by a real-time application operating over a packet based network.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for evaluation of service quality of a real time application operating over a packet-based network. In accordance with one aspect of the present invention there is provided a method for evaluation of perceived quality of a real time application operating over a packet-based network, said method comprising the steps of: actively probing the packet-based network by transmitting one or more sequences of packets along a path of the packet-based network; determining transmission characteristic data for the path, said transmission characteristic data representative of responses of the packet-based network to transmission of the one or more sequences of packets along the path; determining a test signature representative of said transmission characteristic data; and identifying a suitable loss impairment model based on a known signature comparable to the test signature; wherein said suitable loss impairment model provides a means for evaluating the perceived quality of a real-time application operating over a packet-based network.

In accordance with another aspect of the present invention there is provided an apparatus for evaluation of perceived quality of a real time application operating over a packet-based network, said system comprising: means for actively probing the packet-based network by transmitting one or more sequences of packets along a path of the packet-based network; means for determining transmission characteristic data for the path, said transmission characteristic data representative of responses of the packet-based network to transmission of the one or more sequences of packets along the path; means for determining a test signature representative of said transmission characteristic data; means for identifying a suitable loss impairment model based on a known signature comparable to the test signature and determining an equipment impairment factor using the suitable impairment model and the transmission characteristic data; means for determining a transmission rating factor using an appropriate model, said transmission rating factor representative of said perceived quality.

In accordance with another aspect of the present invention there is provided a computer program product comprising a computer readable medium having a computer program recorded thereon which, when executed by a computer processor, cause the processor to execute a method for evaluation of perceived quality of a real time application operating over a packet-based network, said method comprising the steps of: actively probing the packet-based network by transmitting one or more sequences of packets along a path of the packet-based network; determining transmission characteristic data for the path, said transmission characteristic data representative of responses of the packet-based network to transmission of the one or more sequences of packets along the path; determining a test signature representative of said transmission characteristic data; and identifying a suitable loss impairment model based on a known signature comparable to the test signature; wherein said suitable loss impairment model provides a means for evaluating the perceived quality of a real-time application operating over a packet-based network.

### BRIEF DESCRIPTION OF THE FIGURES

FIG. 1 illustrates experimental correlations between mouth-to-ear (M2E) delays and the delay impairment factor (I_{d}).

FIG. 2 illustrates experimental correlations between percent packet loss and the equipment impairment factor Iₑ, for a variety of codecs.

FIG. 3 is a schematic representation of the correlation between the R value determined using the E-model and the Mean Opinion Score (MOS).

FIG. 4 is a schematic view of an example path through a network from a first location to a second location.

FIG. 5 is a schematic representation of a burst load of packets according to one embodiment of the present invention.

FIG. 6 is a schematic representation of a stream of packets according to one embodiment of the present invention.

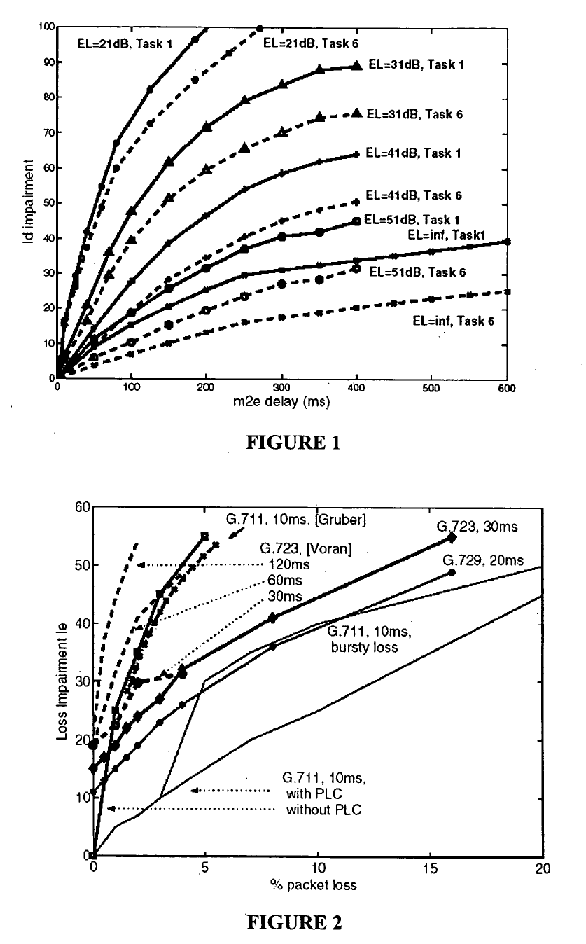

### DETAILED DESCRIPTION OF THE INVENTION

Definitions

The term “transmission characteristic data” is used to define information regarding packets that have traversed a path of a packet-based network. This information can be measured characteristics of the packets traversing the path or alternately can be derived from these measured characteristics.

The term “sequence of packets” is used to define datagrams, bursts or streams of packets. For example, datagrams are single packets transmitted with large inter-packet separations in time. Bursts are groups of a fixed number of packets transmitted with small inter-packet spacing, wherein they are transmitted with large inter-burst separations. Streams are sequences of bursts of fixed size and number transmitted with a fixed separation between the bursts.

The term “test signature” as applied to networks is used to define an organized collection of information relating to a number of sequences of test packets that have traversed a path in a network. A test signature can vary depending upon the way in which the network responds to the test packets and the metrics being evaluated. A test signature can be derived directly or indirectly from transmission characteristic data. Certain network behaviours can generate a characteristic test signature that offers distinct patterns. The information used to define a test signature may be chosen so that different network behaviours are distinguishable on the basis of their unique test signatures. A test signature can also vary with features relating to the particular set of test packets used for the active sampling procedure, such as the sizes of the test packets, inter-packet spacing, the number of test packets sent, the configuration of the test packets and packet protocol, for example. A test signature of a path can comprise information relating to packet loss and delay only, or a test signature can further comprise parameterizations that may be representative of a network condition.

The term “loss impairment model” is used to define a means for representation of a packet-based network's data transmission capabilities with respect to a real time application operating over a packet-based network. A loss impairment model can provide a representation of one or more of current, future and instantaneous transmission characteristics of a packet-based network.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a method and apparatus for determining the service quality performance of a real-time application, for example VoIP, video over IP, or IPTV operating over a path defined in a packet-based network. The present invention performs active probing or sampling of a path of the packet-based network by transmitting one or more sequences of packets along the path. Through the collection of responses to a variety of sequences of packets, for example datagrams, bursts or streams of packets, transmission characteristic data can be evaluated for the path being probed. This transmission characteristic data can provide a means for determining a test signature for the path of the packet-based network being evaluated. This test signature can be used to identify a known signature which is known to represent particular path characteristics. Based on the known signature, a suitable loss impairment model can be identified, wherein the suitable loss impairment model is particularly applicable to a path exhibiting characteristic responses associated with the known signature. Based on the identified suitable loss impairment model a service quality performance of a real-time application, for example VoIP, video over IP or IPTV, can be determined.

In one embodiment, each suitable loss impairment model provides a multivariate representation for the evaluation of a loss impairment factor, providing a means for the determination of a loss impairment factor based on projected information rather than merely based on current path status. For example, a multivariate representation of the loss impairment model can provide projected maximum, minimum and instantaneous evaluations of the loss impairment factor. The loss impairment factor can provide a means for the evaluation of a transmission rating factor using an appropriate model, for example the E-model or other applicable model, which can represent the subjective quality of the path being evaluated for real-time application performance.

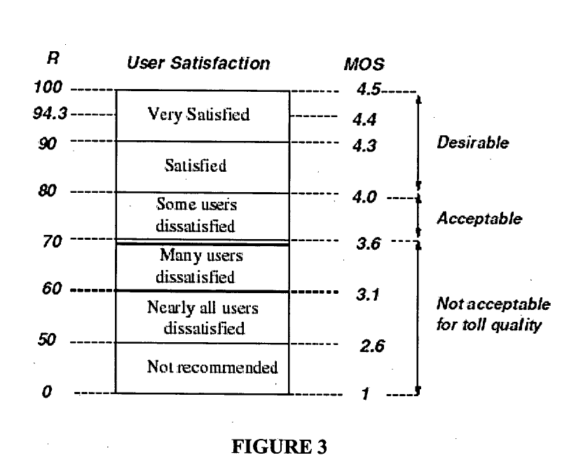

In one embodiment of the present invention, upon the determination of a transmission rating factor for the network path being evaluated for service quality, this transmission rating factor can be mapped directly to a Mean Opinion Score (MOS) which is a commonly used subjective measure for VoIP. The MOS can provide a numerical measure of the quality of human speech at the destination end of the connection. In one embodiment, the transmission rating factor is the R-value as defined by the E-model, wherein FIG. 3 illustrates a schematic representation of the correlation between the R-value and the MOS.

In one embodiment of the present invention, the method for evaluating the service quality of a real-time application operating over a packet-based network comprises the steps of a) transmitting specific combinations of probing packets; b) registering a response by network path elements to the probing packets on a hop by hop basis, wherein a single hop is represented by the portion of a path between adjacent network devices; c) performing an end-to-end network performance characterization of the path through the generation of parameters including bandwidth, utilization, latency, packet loss, reordering and other measures specific to network-level, metrics on a hop-by-hop basis; d) generating end-to-end network diagnostics identifying the nature of performance degradations along the path for example, duplex mismatch, Maximum Transmission Unit (MTU) conflicts, media errors, on a hop-by-hop basis; e) using a test signature to identify a known signature through the selecting of key performance and diagnostic features that can include packet loss as a function of packet size and probe type, type of any identified degradation sources and behaviours and conditions that complicate performance, for example; f) generating a loss impairment factor from a loss impairment model defined for the known signature; and g) determining a MOS value or value range through the mapping of a R-value determined using the E-model augmented with the determined loss impairment factor. In this manner, a predicted service quality can be evaluated for a path of a packet-based network which may be realised upon the use of this path for transmission during a real-time application, like VoIP.

The present invention can be separated into two distinct sections, namely the sampling and identified signature determination and subsequently the identification and application of a suitable loss impairment model based on the identified signature. Upon the application of the suitable loss impairment model an R-value can be determined and may subsequently be mapped to a MOS value or value range thereby generating a service quality assessment of a path of a packet-based network which may be realised upon use of this path during a real-time application.

Sampling, Test Signature Evaluation and Comparison with Known Signatures

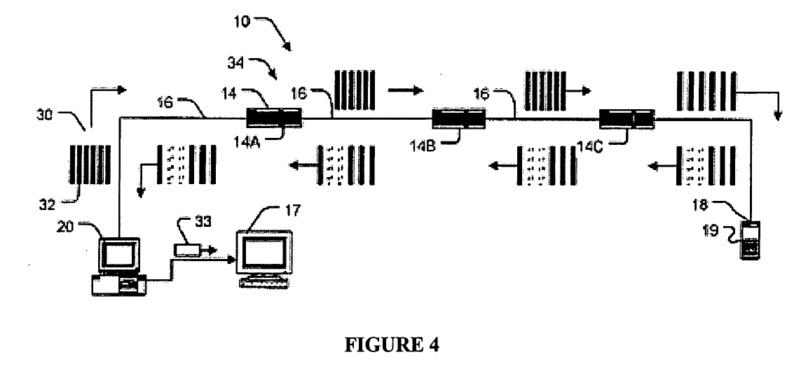

FIG. 4 illustrates an example of a portion of a network 10, wherein the network comprises an arrangement of network devices 14 interconnected by data links 16. The network devices may comprise, for example, routers, switches, bridges, hubs, gateways and the like and the data links may comprise physical media segments such as electrical cables, fibre optic cables, or the like or transmission type media such as radio links, laser links, ultrasonic links, or the like. In addition an analysis system 17 is connected to the network 10.

Also connected to the network 10 are mechanisms for sending one or more sequences of test packets along a path 34 and receiving the test packets after they have traversed the path. In the illustrated embodiment, path 34 is a closed loop, wherein packets originate at a test packet sequencer 20, travel along the path 34 to a reflection point 18, and then propagate back to the test packet sequencer 20. The path, however, does not need to be a closed loop, for example, the mechanism for dispatching test packets may be separated from the mechanism that receives the test packets after they have traversed the path.

The packets being sent along a path during the active probing can be of varying sizes, wherein the largest size of packet is defined by the MTU supported by the path to the selected end host or destination. For example, if a packet larger than the MTU is transmitted during an active probing session, a fragmentation response will typically be received by the test packet sequencer 20.

Furthermore, these one or more sequences of packets transmitted during the active probing can be datagrams, bursts or streams, for example. Datagrams are single packets with large inter-packet separations in time, for example the separation between the single packets can be in the range of hundreds of milliseconds. In addition, tight datagrams are datagrams that are transmitted with relatively small inter-packet spacings. Bursts are groups of a fixed number of packets that are separated by small or virtually zero inter-packet separations. The inter-burst separation in time is relatively large and can be in the range of hundreds of milliseconds. Futhermore, a burstload is an extended burst of many packets back-to-back, which can typically be more than an order of magnitude larger than a burst. For example, a burstload can comprises in the order of hundreds of packets. Finally, streams are sequences of bursts of fixed size and number wherein there is a fixed separation of time between bursts. Each of these sequences of packets can be used to actively sample a path of a network in order to characterise its end-to-end performance, however the level of characterisation is dependent on the form of the sequences of packets used during the active probing session.

In the example portion of a network as illustrated in FIG. 4, the test packet sequencer 20 can record information about the times at which packets are dispatched and times at which returning packets are received. Alternately, wherein the path is a one way, or open path, a first mechanism, for example a test packet sequencer, can be positioned at the origin in order to dispatch a sequence of packets and a second mechanism can be positioned at the destination, and can be used to receive the sequence of packets. In this configuration, the first and second mechanisms would collect timings related to the departure and receipt of a sequence of packets.

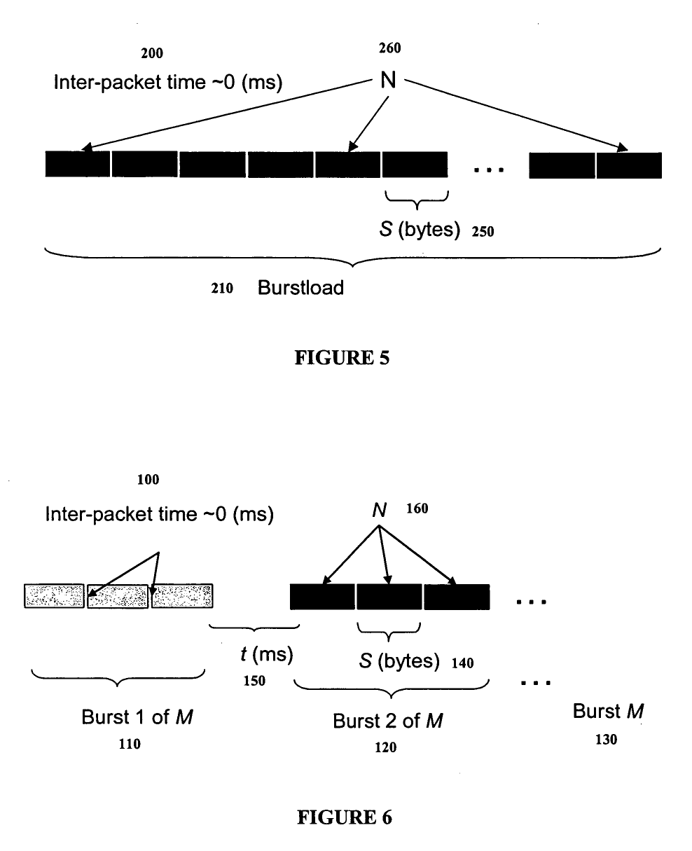

In one embodiment, a burstload according to one embodiment of the present invention is illustrated in FIG. 5. A burstload 210 comprises a plurality of packets for example N packets 260, wherein these packets have an interpacket spacing 200 of approximately a zero interpacket spacing. In this embodiment each packet has been identified as having a size S 250, however in alternate configurations of a burstload the size of the packets can vary within the burstload. Furthermore, the number of packets in a burstload is typically an order of magnitude greater than the number of packets within a burst. For example a burstload can comprise about 100, 200, 400 or other large number of packets.

Having specific regard to streams, this format of a sequence of packets represents a type of network response sampling that is unique to specific applications. For example, in one embodiment a stream is a parameterized sampling that substantially corresponds to a network load generated by real-time application traffic, for example VoIP traffic. As illustrated in FIG. 6, a stream comprises M bursts, 110, 120 and 130, each composed of N packets 160 having a size S, 140, and approximately a zero inter-packet spacing within a burst. Each burst is separated by a fixed timing equal to, t, 150. The parameterization of the values selected for M, N, S and t can be mapped to the choices of codec being used for the real-time application, for example VoIP and the number of simultaneous real-time connections. In one embodiment, appropriate values of the parameters for packet size, S, and burst separation timing, t are defined by the codec being used, and the number of simultaneous real-time connections provides an appropriate value for the burst size, N. In addition, the number of bursts, M, is specific to the resolution of the statistics that are required for a particular active sampling procedure. In one embodiment, the number of bursts used in a sampling procedure is approximately 50, however this can vary depending on the desired detail of path evaluation.

With further reference to the example of a portion of a network path as illustrated in FIG. 4, the test packet sequencer 20 that dispatches one or more sequences of test packets 30 each comprising one or more test packets 32 is connected to the network 14. The path 34 extends from the test packet sequencer 20 through routers 14A, 14B, and 14C to a computer 19 from where the packets are routed back through routers 14C, 14B, and 14A to return to test packet sequencer 20. There are various ways to cause packets 32 to traverse a path 34. For example, the packets 32 may comprise Internet Control Message Protocol (ICMP) ECHO packets directed to end host 19 which will automatically generate an ICMP ECHO REPLY packet in response to each ICMP ECHO packet or alternately an ICMP ECHO packet may result in a ICMP TTL Expiry packet being created in response at some mid-path device. For another example, packets 32 could be another type of packet protocol, such as packets formatted according to the Transmission Control Protocol (TCP) or User Datagram Protocol (UDP) protocol wherein packets of these protocols are port specific and may generate a ICMP Port Unreachable packet from an end host or an ICMP TTL Expiry packet from a mid-path device, for example. Such packets could be sent to end host 19 and then returned to test packet sequencer 20 by software or hardware at end host 19, for example UDP echo daemon software, in the form of a UDP ECHO packet.

As packets 32 pass along path 34 through network devices 14 and data links 16, individual packets 32 may be delayed by different amounts and some packets 32 may be lost in transit. Various characteristics of the network devices 14 and data links 16 along path 34 can be determined by observing how the transmission characteristic data derived from different packets in the sequences varies, which can include measures relating to latency, delay variation, packet loss among others, for example.

Analysis system 17 receives the test data 33, wherein the analysis system may comprise a programmed computer. Analysis system 17 may be hosted in a common device or located at a common location with test packet sequencer 20 or may be separate therefrom. As long as analysis system 17 can receive test data 33, its precise location is a matter of convenience.

Test data 33 comprises information regarding packets which have traversed path 34. This information may include information regarding one or more of lost packets, final inter-packet separation, and information such as hop number, hop address, measured and reported MTU, and error flags. Test data 33 may comprise information regarding one or more of the sequence of packets transmitted including variables such as packet size (the number of bytes in a packet), burst size (the number of packets in a burst), and initial inter-packet separation (the time between packets in a burst at transmission). Further, the Test data 33 may include derivatives of one or more of these variables, for example packet sequence can be derived from inter-packet separation. Higher order variables may also be derived as admixtures of these variables, for example through the use of sequences of packets having a distribution of packet sizes within a distribution of inter-packet separations.

The analysis system furthermore determines transmission characteristic data that can be determined directly or indirectly using the test data. For example transmission characteristic data can be directly related to the network responses or can be analytic measures calculated from the test data. The analysis system 17 can construct a test signature using the transmission characteristic data.

In one embodiment of the present invention, the analysis system can construct a test signature from secondary information collected from alternate sources separate from the sampling as defined above. This secondary information may be used together with the transmission characteristic data or instead of the transmission characteristic data for the construction of a test signature. For example secondary information can be derived from direct queries of nodes along the evaluated path, for examples devices located at the node which can include for example routers, switches, bridges, firewalls, gateways, hubs and similar devices. The secondary information can additionally be derived from alternate path analyses or alternate path evaluation methodologies, for example passive monitoring of the path or analysis of application traffic. In addition, secondary information can be derived from information obtained from a network management system (NMS) or other alternate sources of data representative of the path being evaluated, as would be known to a worker skilled in the art. The use of the secondary information for the construction of a test signature can provide a means for refining the test signature in order that it appropriately represents the network path being evaluated.

In one embodiment of the present invention, the test signature comprises information about packet loss. Packet loss is typically the factor that affects the performance of a network to a large extent. In one embodiment, a test signature may be defined in terms of only packet loss and jitter.

In another embodiment, the test signature may also comprise information about packet order (in the case of bursts), and intra-burst timing. The nature of the packet loss, ordering and timings may be affected by the circumstances of the network at the time of the test including bottleneck capacity, levels of cross traffic, propagation delay to the end host, size of individual packets, and the number of packets per burst.

In some embodiments, the test signature is expressed, at least in part, by a number of continuous functions. The functions may include packet loss statistics, round trip time and final inter-packet separation. The test signature may also include higher-order functions derived from other functions, for example final packet sequence. In some embodiments the test signature is expressed, at least in part by a number of discrete functions which may include discretized continuous functions. This involves taking only a certain number of discrete values as representative of the continuity of possible values. In one embodiment, fixed ranges may be assigned to the variables.

In certain cases, the analysis system 17 compares the test signature to known signatures in a signature library that contains signatures exemplifying certain network conditions. The signature library may comprise a data store wherein the known signatures are available in one or more data structures. The analysis system 17 may perform the comparison of the test signature to the known signatures by computing a similarity measure or “goodness of fit” between the test signature and the known signatures. Based on the level of match between the test signature and a known signature, one or more diagnostic inferences of the path evaluated, can be determined.

The test signature for a particular path under evaluation can be representative of the information that is collected and the transmission characteristic data that can be determined. For example a test signature can be based on 1) the available direct network responses only, 2) direct network responses, analytic measures and available diagnostic inferences by category only, 3) direct network responses, analytic measures and diagnostic inferences by type. This test signature is subsequently used to identify a known signature that is associated with a suitable loss impairment model, thereby enabling the evaluation of an appropriate loss impairment factor, Iₑ. The evaluated loss impairment factor can be used with an appropriate model, for example the E-model, for evaluation of the subjective quality of a real-time application operating over the actively probed path of a packet-based network.

In one embodiment of the present invention, direct network responses comprise packet delay variation or jitter, Δ, packet loss, λ, and reordering, ρ. Each of these direct network responses can be further defined in terms of the type of sequences of packets used during the active probing of the path for use with the loss impairment models. For example, jitter for small datagrams is defined as Δ_{sd}, jitter for small bursts is defined as Δ_{sb}, and jitter for streams is defined as Δₛₜᵣ. In addition, packet loss for small datagrams is defined as λ_{sd}, packet loss for small bursts is defined as λ_{sb}, and packet loss for streams is defined as λₛₜᵣ. Finally, reordering for small bursts is defined as ρ_{sb}, and reordering for streams is defined as ρₛₜᵣ.

In one embodiment of the present invention, analytic measures comprise maximum achievable bandwidth BWₘₐₓ, available bandwidth BWₐᵥₐᵢₗ, latency l, and miscellaneous measures (for example, incidental ICMP errors).

In one embodiment of the present invention diagnostic inferences comprise identified dysfunctions and related path characteristics. An identified dysfunction can be further subdivided into those identified by category, by type or by strength of identification. In addition, related path characteristics can be further subdivided by category, for example path behaviour or protocol behaviour, or by type for example, Generic Routing Encapsulation/Virtual Private Network (GRE/VPN) tunnel, rate-limiting or MTU boundary.

Loss Impairment Models

The test signature evaluated during the active probing is used to identify a known signature, wherein this known signature is associated with a suitable loss impairment model. Therefore a test signature would be generated and compared to compatibly generated known signatures, thereby providing a means for identifying a suitable loss impairment model. Based on the identified suitable loss impairment model a service quality performance of a real-time application, for example VoIP, can be determined.

In one embodiment an appropriate loss impairment factor can be determined for the path being evaluated based on the identified suitable loss impairment model. A loss impairment factor can represent current conditions or can be predictive of potential future conditions, for example as can be defined by predicted maximum or predicted minimum evaluations of the loss impairment factor which can thereby be representative of the worst and best performance, respectively, of the path of the packet-based network being evaluated. The loss impairment factor can provide a means for the evaluation of a transmission rating factor using an appropriate model, for example the E-model or other applicable model, which can represent the subjective quality of the path being evaluated for real-time application performance.

In one embodiment of the present invention the loss impairment models can be defined by three tiers, which are representative of the manner in which the known signatures for the tier were determined.

In one embodiment of the present invention, the loss impairment models are defined by the following three tiers, 1) Direct Loss Response, 2) Dysfunction Category and 3) Dysfunction Type/Intensity. Specifically, Direct Loss Response tier is used to evaluate the loss impairment factor when a test signature is determined based on the available direct network responses only. The Dysfunction Category tier is used when a test signature is determined based on direct network responses, analytic measures and available diagnostic inferences by category only. Finally, the Dysfunction Type/Intensity tier is used when a test signature is determined based on direct network responses, analytic measures and diagnostic inferences by type.

Tier 1: Direct Loss Response

The known signatures that can be associated with this tier of loss impairment models are derived from information comprising direct measures of loss and discard or jitter, relating to the packets transmitted during active probing. The loss directly measured by a variety of probe types can provide a form of explicit measure of the network path's tendencies to packet loss. Each probe type can represent different aspects of the path's response to network traffic and may differentiate performance factors between application types.

For this tier of loss impairment models, the loss impairment factor is derived from direct measures of loss and discards, which can be based on the codec and these measures can be derived from jitter and reordering of the transmitted packets.

In one embodiment of the present invention, loss can be characterised by transmitting packets as small datagrams, small bursts or streams, wherein each provides information relating to the behaviour of the network path being evaluated. For example, the loss associated with small datagrams can represent the average effect a network path has on any small packets and this characterisation can be independent of load. The packet loss associated with small bursts can represent the effect a network path has on small packets, at maximum load. And the packet loss associated with streams can represent the effect on decoder-specific packets, at a selected load.

In one embodiment of the present invention, discards can be characterised by the transmission of small datagrams and the evaluation of the resulting jitter. In addition, streams can be used to characterise discards, for example they can be used to determine jitter and reordering. In one embodiment, the effect on tight datagrams, for example datagrams transmitted with relatively small inter-packet separations, compared with respect to the packet protocol, for example ICMP vs. UDP, can define the applicability of an ICMP-based loss response.

The projected effective loss, which is represented by direct loss λ plus jitter/reordering induced discards, δ(Δ), can be used to define the loss impairment factor in terms of a minimum value, a maximum value and an instantaneous value.

A minimum loss impairment factor can be derived from the effective loss of small datagrams, wherein effective small datagram loss can be defined as follows:
λ_{sd}+δ(Δ_{sd}) (2)
where λ_{sd} is packet loss evaluated for small datagrams, Δ_{sd} is jitter evaluated for small datagrams and δ(Δ_{sd}) is the discards due to jitter.

A maximum loss impairment factor can be derived from the effective loss of small packet bursts, wherein effective average small burst loss can be defined as follows:
λ_{sb}+δ(Δ_{sb},ρ_{sb}) (3)
where λ_{sb} is packet loss evaluated for small bursts, Δ_{sb} is jitter evaluated for small bursts and ρ_{sb} is reordering evaluated for small bursts, and δ(Δ_{sb},ρ_{sb}) is the discards due to jitter and reordering.

An instantaneous loss impairment factor can be derived from effective loss of tight datagrams, wherein effective tight datagram loss can be defined as follows:
λₛₜᵣ+δ(Δₛₜᵣ,ρₛₜᵣ) (4)
where λₛₜᵣ is packet loss evaluated for streams, Δₛₜᵣ is jitter evaluated for streams and ρₛₜᵣ is reordering evaluated for streams, and δ(Δₛₜᵣ,ρₛₜᵣ) is the discards due to jitter and reordering.
Tier 2: Dysfunction Category

The known signatures that can be associated with this tier of loss impairment models are derived from information comprising direct network responses, analytic measures and available diagnostic inferences by category only, which can be evaluated based on the configuration of packets transmitted during active probing. The dysfunction category is determined based on coarse-grained refinement of loss/discard projections based on the results from active probing. In this tier, the loss directly detected may indicate a particular mode of loss dysfunction. Each mode has a high-level loss behaviour model that offers a coarse-grained predictive view. The identification of a category of dysfunction may define how to interpret direct measures, how to apply other measures, or coarse functions for modelling augmented loss. In one embodiment, this tier comprises five modes, namely tail limiting, stochastic, head limiting, funnel and dropout.

Tail Limiting Mode

The tail limiting mode is characterised by the loss of burst packets due to clipping by one or more mechanisms along the path such that there is little or no small burst packet loss, clear end-of-burst loss on large burst packets, clear end-of-burst loss on medium burst packets, little or no datagram loss and little or no tight datagram loss when actively probing using either ICMP or UDP protocols.

The tail limiting mode typically experiences loss when there is a high load, for example when packets comprise a large number of bytes, and this packet loss typically only occurs with large packets. In addition, in the tail limiting mode, packet loss may also only occur when actively probing using a particular protocol, for example ICMP.

For the tail limiting mode, the projected packet loss behaviour, which can provide a means for the evaluation of the loss impairment factor for this mode, can be 1) a minimum loss based on the response of the path to the transmission of tight datagrams; 2) an incremental loss if there is packet loss when small datagrams are used; 3) otherwise there is no added loss projection.

Stochastic Mode

The stochastic mode is representative of the loss of packets due to a form of quasi-random mechanism, for example corruption along the path or congestion along the path. The stochastic mode is characterised by the loss of packets in all samples formats and all packet sizes, however there may be a form of bias in size and/or sample type in a burst, for example. There typically is no head or tail bias, wherein loss is pre-dominant at the beginning or the end of a burst, represented within the stochastic mode.

The Stochastic mode experiences packet loss under all conditions, may be sensitive to load size, and affects all packets and all protocols.

For the stochastic mode, the projected packet loss behaviour, which can provide a means for the evaluation of the loss impairment factor for this mode, can be a minimum loss when based on the path response to tight datagrams and an augmented loss when high utilization of the path is detected.

Head Limiting Mode

The head limiting mode is characterized by the loss of packets due to clipping by one or more mechanisms such that there is little or no loss in datagrams or tight datagrams, a strong loss response in large burst packets, and clear beginning-of-burst loss.

Typically the head limiting mode experiences loss when the path is under load and may be protocol specific if packet loss is very high for bursts but low to none for datagrams.

For the head limiting mode, the projected packet loss behaviour, which can provide a means for the evaluation of the loss impairment factor for this mode, can be a minimum loss for tight datagrams and can be an augmented loss under high load conditions.

Funnel Mode

The funnel mode is represented by packet loss due to issues with small packet handling and is characterized by packet loss that primarily occurs with small packet bursts, wherein there is little or no loss on datagrams or tight datagrams and little or no loss with the transmission of large packets.

The funnel mode experiences loss when the path is under load and this load comprises primarily small packets. In addition, high small packet jitter conditions may also indicate a funnel mode, for example.

For the funnel mode, the projected packet loss behaviour, which can provide a means for the evaluation of the loss impairment factor for this mode, can be a minimum loss when referenced by tight datagram loss and can be a maximum loss when referenced by small packet burst loss.

Dropout Mode

The dropout mode is represented by packet loss due to intermittent connectivity and is characterized by periods of 100% packet loss for groups of transmitted packet sequences, and no loss detected during other periods.

The Dropout mode experiences loss which may be highly intermittent and affects all packets.

For the dropout mode, the projected packet loss behaviour, which can provide a means for the evaluation of the loss impairment factor for this mode, can be defined as a maximum loss when the packet loss is detected for tight datagrams and can be defined as a minimum loss when related to any sub-burst loss. For this mode the detected packet loss is typically accurate, however, this level of loss may not be representative.

Tier 3: Dysfunction Type/Intensity

The known signatures that can be associated with this tier of loss impairment models are derived from information comprising direct network responses, analytic measures and diagnostic inferences by type, which can be evaluated based on the configuration of the packets transmitted during active probing. The dysfunction type/intensity tier is defined by a distinctive loss response that may identify a specific source or type of loss impairment, further enabling the specification of the strength or “certainty” of the identification as a relative measure. From this identification of the path response to active probing, a unique loss behaviour can be modelled that is extensively parameterized by the performance characterization of the network path. For example, although traffic congestion and media errors belong to the same category and can be defined as a stochastic loss and may generate similar appearing loss responses, the sensitivity of the loss under load or change of bandwidth can be very different, thereby resulting is a different loss impairment model being applied to these two network conditions.

The following provides a plurality of identifiable network conditions and their respectively associated a suitable loss impairment model. This represents a non-exhaustive sampling of possible network conditions and respective loss impairment models. It would be known that through experimentation further network conditions and their respective loss impairment model can be determined and would be considered to be within the scope of the present invention.

For each of the following network conditions, the loss impairment model, which is used to determine a loss impairment factor, is defined in terms of a minimum value, a maximum value and an instantaneous value. The loss impairment factor is a function of the effective loss and can be derived by a variety of means. For example, in one embodiment wherein the E-model is being used, the loss impairment factor typically has a value within the E-model in the range of 0 to 100 where 0 represents no impairment and 100 is the maximum impairment possible in terms of the transmission rating factor, R.

In one embodiment, the loss impairment factor is derived from empirical studies of specific codecs and hardware, producing functions that are fitted approximations of the data. By specifying the codec and the effective loss, an impairment factor can subsequently be returned that corresponds to the empirical measures. Alternate embodiments may provide functions that are derived from theoretical models of codecs, hardware and applications.

Full/Half-Duplex Mismatch

A full-half duplex mismatch is a condition that can occur where, as a result of a configuration mistake or as a result of the failure of an automatic configuration negotiation two interfaces on a given link are not using the same duplex mode. If the upstream interface is using full duplex and the downstream host is using half duplex then a full-half duplex mismatch condition exists. This condition is typified by packets at the ends of bursts being dropped. This is especially pronounced for larger packet sizes. This condition affects all sizes and types of packets and a strongest loss response can be generated when active probing is performed using large packet bursts sent two-way. The amount of loss is typically a function of the distance between interfaces, bandwidth, and cross-traffic. Furthermore the actual loss levels can be strongly dependent on cross-traffic.

A minimum loss impairment factor for this network condition can be defined as follows:
Iₑ=0.0 (5)

A maximum loss impairment factor for this network condition can be derived from the effective loss modelled by the following:
f(BWₘₐₓ,BWₐᵥₐᵢₗ)+δ(Δ_{sb},ρ_{sb}) (6)
where BWₘₐₓ is the maximum achievable bandwidth, BWₐᵥₐᵢₗ is the available bandwidth, Δ_{sb} is the jitter evaluated for small bursts and ρ_{sb} is the reordering evaluated for small bursts, and f(BWₘₐₓ,BWₐᵥₐᵢₗ) is a function of maximum and available bandwidth, and δ(Δ_{sb},ρ_{sb}) is the discards due to jitter and reordering. In one embodiment, the function f(BWₘₐₓ,BWₐᵥₐᵢₗ) may be a theoretical model of packet loss for full/half duplex mismatch or alternately, it may be derived empirically from studied behaviours.

An instantaneous loss impairment factor for this network condition can be derived from the effective loss modelled by the following:
λₛₜᵣ+δ(Δₛₜᵣ,ρₛₜᵣ) (7)
where λₛₜᵣ is the packet loss evaluated for streams, Δₛₜᵣ is the jitter evaluated for streams and ρₛₜᵣ is the reordering evaluated for streams and δ(Δₛₜᵣ,ρₛₜᵣ) is the discards due to jitter and reordering.
Half/Full-Duplex Mismatch

A half-full duplex mismatch is a condition that can occur where, as a result of a configuration mistake or as a result of the failure of an automatic configuration negotiation, two interfaces on a given link are not using the same duplex mode. If the upstream interface is using half duplex and the downstream host is using fill duplex then a half-full duplex mismatch condition exists. This condition is typified by the dropping of packets at the beginning of bursts. This condition is especially pronounced for larger packet sizes. In addition, this condition affects all sizes and types of packets and a strongest loss response can be generated when active probing is performed using large packet bursts sent two-way. The amount of loss is typically a function of distance between interfaces, bandwidth, and cross-traffic, wherein the loss can tend to be irregular, somewhat “bursty”, and levels of loss can be strongly dependent on cross-traffic.

A minimum loss impairment factor for this network condition can be defined as follows:
Iₑ=0.0 (8)

A maximum loss impairment factor for this network condition can be derived from the effective loss modelled by the following:
f(BWₘₐₓ,BWₐᵥₐᵢₗ)+δ(Δ_{sb},ρ_{sb}) (9)
where BWₘₐₓ is the maximum achievable bandwidth, BWₐᵥₐᵢₗ is the available bandwidth, Δ_{sb} is the jitter evaluated for small bursts and ρ_{sb} is the reordering evaluated for small bursts, and f(BWₘₐₓ,BWₐᵥₐᵢₗ) is a function of maximum and available bandwidth, and δ(Δ_{sb},ρ_{sb}) is the discards due to jitter and reordering. In one embodiment, the function f(BWₘₐₓ,BWₐᵥₐᵢₗ) may be a theoretical model of packet loss for half/full duplex mismatch; alternately, it may be derived empirically from studied behaviours.

An instantaneous loss impairment factor for this network condition can be derived from the effective loss modelled by the following:
λₛₜᵣ+δ(Δₛₜᵣ,ρₛₜᵣ) (10)
where λₛₜᵣ is the packet loss evaluated for streams, Δₛₜᵣ is the jitter evaluated for streams and ρₛₜᵣ is the reordering evaluated for streams, and δ(Δₛₜᵣ,ρₛₜᵣ) is the discards due to jitter and reordering.
Media Errors

A media error condition may result where factors such as poorly seated cards, bad connectors, electromagnetic interference, or bad media introduce stochastic noise into a data link. For this condition, the packets being transmitted are typically corrupted while in transit resulting in their discard at the receiving interface. The loss is typically continuous, random (non-contiguous loss), low-level, and independent of traffic levels and other layer 3 considerations. Further, the loss affects packets according to the time they are in transit, and therefore is specific to packet size.

A minimum loss impairment factor for this network condition can be derived from the effective loss modelled by the following:
min(λ_{sd},λₛₜᵣ) (11)
where λ_{sd} is the packet loss evaluated for small datagrams and λₛₜᵣ is the packet loss evaluated for streams, and min( ) is the minimum value.

A maximum loss impairment factor for this network condition can be derived from the effective loss modelled by the following:
max(λ_{sb},λₛₜᵣ) (12)
where λ_{sd} is the packet loss evaluated for small bursts and λₛₜᵣ is the packet loss evaluated for streams, and max( ) is the maximum value.

An instantaneous loss impairment factor for this network condition can be derived from the effective loss modelled by the following:
λₛₜᵣ+δ(Δₛₜᵣ,ρₛₜᵣ) (13)
where λₛₜᵣ is the packet loss evaluated for streams, Δₛₜᵣ is the jitter evaluated for streams and ρₛₜᵣ is the reordering evaluated for streams, and δ(Δₛₜᵣ,ρₛₜᵣ) is the discards due to jitter and reordering.
Congestion

A congestion condition can result when packets are discarded at mid-path store-and-forward devices whose queues are full due to high levels of traffic. Packet loss associated with this condition tends to be “bursty” (contiguous packet loss) and can be highly variable. Packet loss associated with this condition corresponds strongly to traffic level.

A minimum loss impairment factor for this network condition can be defined as follows:
Iₑ=0.0 (14)

A maximum loss impairment factor for this network condition can be derived from the effective loss modelled by the following:
f(BWₘₐₓ,BWₐᵥₐᵢₗ)+δ(Δ_{MbyteQ}(Bw)) (15)
where BWₘₐₓ is the maximum achievable bandwidth, BWₐᵥₐᵢₗ is the available bandwidth, Δ_{MbyteQ}(BW) is the jitter evaluated for a 1 Mbyte-sized queue on a store-and-forward device, for example a router, and f(BWₘₐₓ,BWₐᵥₐᵢₗ) is a function of maximum and available bandwidth, and δ(Δ_{MbyteQ}(BW)) is the discards due to the evaluated jitter. In one embodiment the function f(BWₘₐₓ,BWₐᵥₐᵢₗ) may be a theoretical model of packet loss for congestion and alternately, it may be derived empirically from studied behaviours. Similarly, in one embodiment the function Δ_{MbyteQ}(BW) may be a theoretical model for jitter or derived from empirical studies.

An instantaneous loss impairment factor for this network condition can be derived from the effective loss modelled by the following:
λₛₜᵣ (16)
where λₛₜᵣ is the packet loss evaluated for streams.
MTU Conflict/Black/Grey Hole

MTU conflict/black/grey hole condition is a condition that occurs where a host or other packet handling device reports or is discovered to permit a certain MTU and subsequently uses a smaller MTU. As an example, packets that are larger than the MTU of the network path and are marked with the “Do Not Fragment” bit are typically discarded. RFC1191 protocol requires that under this circumstance an ICMP notice be sent back to the originating interface. If this ICMP response is not sent, has incorrectly identified the path MTU (pMTU), is lost, or is ignored, packets larger than the pMTU may be lost. This condition is typified by packets which are larger than the smaller MTU being dropped and as such packet loss is 100% for packets larger than this critical size. For example, a black hole can be defined as a condition that arises when a “packet to big” message, for example ICMP message, is not transmitted when required. A grey hole can be defined as a condition where a “packet to big” message is sent however, this message identifies an incorrect allowable MTU packet size.

A minimum loss impairment factor for this network condition can be defined as follows:
Iₑ=0.0 (17)

A maximum loss impairment factor for this network condition can be derived from the effective loss modelled by the following:
λₛₜᵣ (18)
where λₛₜᵣ is the packet loss evaluated for streams.

An instantaneous loss impairment factor for this network condition can be derived from the effective loss modelled by the following:
λₛₜᵣ (19)
where λₛₜᵣ is the packet loss evaluated for streams.
Intermittent Connectivity

An intermittent connectivity condition occurs when connectivity along the path being evaluated is intermittently broken, wherein during a period of non-connectivity there is a 100% loss of all packets. This condition is typically not dependent on any other network path performance factor and this lost can be defined as “bursty” (contiguous packets), independent of packet size, and 100% during loss events.

A minimum loss impairment factor for this network condition can be defined as follows:
Iₑ=0.0 (20)

A maximum loss impairment factor for this network condition can be defined as follows:
Iₑ=1.0 (21)

An instantaneous loss impairment factor for this network condition can be derived from the effective loss modelled by the following:
λₛₜᵣ (22)
where λₛₜᵣ is the packet loss evaluated for streams.
Collision Domain Violation

A collision domain violation condition defines a situation when packets that are in-flight beyond the period of the collision domain on a half-duplex link experience collisions resulting in loss. This condition requires the presence of a half-duplex media for example Ethernet, Fast Ethernet, WLAN, microwave/laser/radio, that has been configured to operate beyond its specified parameters. For this condition, small packets are affected more strongly than large packets and loss levels are intermittent, somewhat bursty, and strongly dependent on traffic levels.

A minimum loss impairment factor for this network condition can be derived from the effective loss modelled by the following:
λ_{sd}+δ(Δ_{sd}) (23)
where λ_{sd} is the packet loss evaluated for small datagrams, Δ_{sd} is the jitter evaluated for small datagrams, and δ(Δ_{sd}) is the discards due to jitter.

A maximum loss impairment factor for this network condition can be derived from the effective loss modelled by the following:
max(λ_{sd},λₛₜᵣ,λ_{sb})+δ(Δ_{sb},ρ_{sb}) (24)
where λ_{sd} is the packet loss evaluated for small datagrams, λₛₜᵣ is the packet loss evaluated for streams, λ_{sb} is the packet loss evaluated for small bursts, Δ_{sb} is the jitter evaluated for small bursts and ρ_{sb} is the reordering evaluated for small bursts, and max( ) is the maximum value, and δ(Δ_{sb},ρ_{sb}) is discards due to jitter and reordering.

An instantaneous loss impairment factor for this network condition can be derived from the effective loss modelled by the following:
λₛₜᵣ (25)
where λₛₜᵣ is the packet loss evaluated for streams.
Rate-Limiting Queue

A rate-limiting queue condition defines a situation where packets are discarded by a deliberate, rate-limiting mechanism that intends to reduce traffic through TCP feedback, for example loss based on a congestion signal. For example, the rate-limiting mechanism may be configured to discard packets having a particular number of bytes, bursts having a particular number of packets or packets originating from a particular source or having a particular destination. For this condition, the loss behaviour tends to be variable and dependent on traffic levels. For example small packets are more strongly affected by limiting against packet number; large packets are more strongly affected by limiting against payload size, which is a typical configuration of a rate-limiting mechanism. For example, assuming a typical case of limiting for bytes, small packets are likely only impacted when utilization exceeds the rate threshold for the path being evaluated.

A minimum loss impairment factor for this network condition can be defined as follows:
Iₑ=0.0 (26)

A maximum loss impairment factor for this network condition is derived from the effective loss modelled by the following:
f(BWₘₐₓ,BWₐᵥₐᵢₗ)+δ(Δ_{measuredQ}(BW)) (27)
where BWₘₐₓ is the maximum achievable bandwidth, BWₐᵥₐᵢₗ is the available bandwidth, Δ_{measuredQ}(BW) is the jitter evaluated for a queue of specific size on a store-and-forward device like a router, and f(BWₘₐₓ,BWₐᵥₐᵢₗ) is a function of maximum and available bandwidth, and δ(Δ_{MbyteQ}(BW)) is the discards due to the evaluated jitter. In one embodiment the function f(BWₘₐₓ,BWₐᵥₐᵢₗ) may be a theoretical model of packet loss for congestion and alternately, it may be derived empirically from studied behaviours. Similarly, in one embodiment the function Δ_{MbyteQ}(BW) may be a theoretical model for jitter or derived from empirical studies. The size of the queue can be derived from the loss experienced by large packet bursts.

An instantaneous loss impairment factor for this network condition can be derived from the effective loss modelled by the following:
λₛₜᵣ (28)
where λₛₜᵣ is the packet loss evaluated for streams.
Firewall Limiting

A firewall limiting condition defines a situation wherein a firewall deliberately limits packets, typically by protocol such as ICMP, as a security measure. The packet limiting tends to be extremely specific, and can target packet numbers over long periods of time. The packet loss levels are strongly dependent on the amount of originating traffic and typically do not affect accepted traffic, for example packets having UDP/TCP protocol as they are directed to specific ports. This condition appears to mimic intermittent connectivity and may also involve behaviour reflective of a MTU conflict/black/grey hole condition.

A minimum loss impairment factor for this network condition can be defined as follows:
Iₑ=0.0 (29)

A maximum loss impairment factor for this network condition can be derived from the effective loss modelled by the following:
2*λₛₜᵣ (30)
where λₛₜᵣ is the packet loss evaluated for streams.

An instantaneous loss impairment factor for this network condition can be derived from the effective loss modelled by the following:
λₛₜᵣ (31)
where λₛₜᵣ is the packet loss evaluated for streams.
Router Loops

A router loop condition can generate periods of 100% packet loss and is related to looping in packet routes. The period of packet loss can depend on the rate of route change and typically is relatively long in the range of minutes. It addition a source for this condition can typically be identified, distinguishing Router Loops from the general case of Intermittent Connectivity that may be caused by other network conditions.

A minimum loss impairment factor for this network condition can be defined as follows:
Iₑ=0.0 (32)

A maximum loss impairment factor for this network condition can be defined as follows:
Iₑ=1.0 (33)

An instantaneous loss impairment factor for this network condition can be derived from the effective loss modelled by the following:
λₛₜᵣ (34)
where λₛₜᵣ is the packet loss evaluated for streams.
Header Congestion

Header congestion can occur when a device located mid-path or at the end of the path, tends to drop small packets during periods of high rate of IP header processing. This dysfunction type is distinct from normal congestion, which results from a bandwidth constraint in terms of raw bytes per second. Header congestion involves packet loss due to a limited capacity for processing the headers of the transmitted packets, which is a constraint in terms of packets per second. Typically, header congestion tends to only affect bursts of small packets at high data rates where inter-header separation is very small.

A minimum loss impairment factor for this network condition can be defined as follows:
Iₑ=0.0 (35)

A maximum loss impairment factor for this network condition can be derived from the effective loss modelled by the following:
f(BWₘₐₓ,BWsbₘₐₓ,BWsbₐᵥₐᵢₗ)+δ(Δ(BWsb)) (36)
where BWₘₐₓ is the maximum achievable bandwidth, BWsbₘₐₓ is the maximum achievable bandwidth afforded by small bursts, BWsbₐᵥₐᵢₗ is the available bandwidth determined from small bursts, and f( ) is a function of maximum and available bandwidths, and δ(Δ) is the discards due to the evaluated jitter. In one embodiment the function f( ) may be a theoretical model of packet loss for header congestion and alternately, it may be derived empirically from studied behaviours. Similarly, in one embodiment the function Δ(BWsb) may be a theoretical model for jitter or derived from empirical studies.

An instantaneous loss impairment factor for this network condition can be derived from the effective loss modelled by the following:
λₛₜᵣ (37)
where λₛₜᵣ is the packet loss evaluated for streams.
Variations

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as a personal computer, server or the like and pursuant to one or more, or a part of one or more, program elements, modules or objects generated from any programming language, such as C++, Java, P1/1, or the like. In addition, each step, or a file or object or the like implementing each said step, may be executed by special purpose hardware or a circuit module designed for that purpose.

All such modifications as would be obvious to one skilled in the art are intended to be included within the scope of the following claims.

We claim:

1. A method for evaluation of perceived quality of a real time application operating over a packet-based network, said method comprising the steps of:
(a) actively probing the packet-based network by transmitting one or more sequences of packets along a path of the packet-based network;
(b) determining transmission characteristic data for the path, said transmission characteristic data representative of responses of the packet-based network to transmission of the one or more sequences of packets along the path;
(c) determining a test signature representative of said transmission characteristic data; and
(d) identifying a suitable loss impairment model based on a known signature comparable to the test signature;
wherein said suitable loss impairment model provides a means for evaluating the perceived quality of a real-time application operating over a packet-based network.

2. The method according to claim 1, further comprising the steps of determining an equipment impairment factor using the suitable impairment model and the transmission characteristic data and determining a transmission rating factor using an appropriate model, wherein said transmission rating factor is representative of the perceived quality.

3. The method according to claim 1, wherein each of the one or more sequences of packets is selected from the group comprising a datagram, tight datagram, burst, burstload and stream.

4. The method according to claim 1, wherein the one or more sequences of packets are configured using one or more protocols selected from the group comprising Internet Control Protocol, Transmission Control Protocol and User Datagram Protocol.

5. The method according to claim 1, wherein the suitable impairment model is representative of current performance of the path of the packet-based network.

6. The method according to claim 1, wherein the suitable impairment model is representative of future performance of the path of the packet-based network.

7. The method according to claim 6, wherein the suitable impairment model is representative of a minimum future performance of the path of the packet-based network.

8. The method according to claim 6, wherein the suitable impairment model is representative of a maximum future performance of the path of the packet-based network.

9. The method according to claim 1, wherein the step of identifying a suitable loss impairment model is further based on evaluation of secondary information.

10. The method according to claim 9, wherein the secondary information is collected from one or more of passive monitoring of the path, direct queries of one or more devices along the path, and queries of a network management system.

11. The method according to claim 1, wherein the suitable loss impairment model is representative of one or more of loss, discard and jitter relating to the one or more sequences of packets transmitted along the path.

12. The method according to claim 1, wherein the suitable loss impairment model is representative of a mode of response of the path corresponding to a category of impairment.

13. The method according to claim 12, wherein the mode of response of the path is selected from the group comprising, tail limiting mode, stochastic mode, head limiting mode, funnel mode and dropout mode.

14. The method according to claim 1, wherein the suitable loss impairment model is representative of a type of response of the path corresponding to a specific impairment.

15. The method according to claim 14, wherein the type of response of the path is selected from the group comprising, full/half-duplex mismatch, half/full-duplex mismatch, media errors, congestion, MTU conflict/black/grey hole, intermittent connectivity, collision domain violation, rate-limiting queue, firewall limiting, router loops and header congestion.

16. The method according to claim 1, wherein the test signature is representative of loss patterns of the one or more sequences of packets.

17. The method according to claim 15, wherein the test signature is further representative of discards of the one or more sequences of packets.

18. The method according to claim 15, wherein the test signature is further representative of evaluated metrics.

19. The method according to claim 1, wherein the path is a closed loop.

20. The method according to claim 1, wherein the path is a one-way path or an open path.

21. An apparatus for evaluation of perceived quality of a real time application operating over a packet-based network, said system comprising:
(a) means for actively probing the packet-based network by transmitting one or more sequences of packets along a path of the packet-based network;
(b) means for determining transmission characteristic data for the path, said transmission characteristic data representative of responses of the packet-based network to transmission of the one or more sequences of packets along the path;
(c) means for determining a test signature representative of said transmission characteristic data;
(d) means for identifying a suitable loss impairment model based on a known signature comparable to the test signature and determining an equipment impairment factor using the suitable impairment model and the transmission characteristic data;
(e) means for determining a transmission rating factor using an appropriate model, said transmission rating factor representative of said perceived quality.

22. The apparatus according to claim 21, further comprising:
(a) means for determining an equipment impairment factor using the suitable impairment model and the transmission characteristic data; and
(b) means for determining a transmission rating factor using an appropriate model;
wherein said transmission rating factor is representative of the perceived quality.

23. The apparatus according to claim 21, wherein the path of the packet-based network is a closed loop and the means for actively probing comprises a mechanism for dispatching and receiving the one or more sequences of packets.

24. The apparatus according to claim 21, wherein the path of the packet-based network is an open path and the means for actively probing comprises a first mechanism for dispatching the one or more sequences of packets and a second mechanism for receiving the one or more sequences of packets.

25. A computer program product comprising a computer readable medium having a computer program recorded thereon which, when executed by a computer processor, cause the processor to execute a method for evaluation of perceived quality of a real time application operating over a packet-based network, said method comprising the steps of:
(a) actively probing the packet-based network by transmitting one or more sequences of packets along a path of the packet-based network;
(b) determining transmission characteristic data for the path, said transmission characteristic data representative of responses of the packet-based network to transmission of the one or more sequences of packets along the path;
(c) determining a test signature representative of said transmission characteristic data; and
(d) identifying a suitable loss impairment model based on a known signature comparable to the test signature;
wherein said suitable loss impairment model provides a means for evaluating the perceived quality of a real-time application operating over a packet-based network.

26. The computer program product according to claim 25, wherein the method further comprises the steps of determining an equipment impairment factor using the suitable impairment model and the transmission characteristic data and determining a transmission rating factor using an appropriate model, wherein said transmission rating factor is representative of the perceived quality.
